(19) United States
(12) Patent Application Publication
(10) Pub. No.: US 2024/0412556 A1
(43) Pub. Date: Dec. 12, 2024

(54) MULTI-MODAL FACIAL FEATURE EXTRACTION USING BRANCHED MACHINE LEARNING MODELS

(71) Applicant: Samsung Electronics Co., Ltd., Suwon-si (KR)

(72) Inventors: Sumit Jha, Irvine, CA (US); Tien C. Bau, Irvine, CA (US)

(21) Appl. No.: 18/527,036

(22) Filed: Dec. 1, 2023

Related U.S. Application Data
(60) Provisional application No. 63/471,683, filed on Jun. 7, 2023.

(51) Int. Cl. G06V 40/16; G06V 10/70

(52) U.S. Cl. CPC G06V 40/161; G06V 10/70

(57) ABSTRACT

A method for using a machine learning model having a base model and multiple branch models includes obtaining an image containing a face and processing the image using the base model to generate intermediate data. The method also includes processing the intermediate data using a first of the branch models to perform a first image processing task, where the first image processing task is associated with analyzing the image containing the face. The method further includes processing the intermediate data using a second of the branch models to perform a second image processing task different from the first image processing task, where the second image processing task is associated with analyzing the image containing the face. The base model and the first branch model are trained using a first dataset, and the base model and the second branch model are trained using a second dataset different from the first dataset.

### CROSS-REFERENCE TO RELATED APPLICATION AND PRIORITY CLAIM

This application claims priority under 35 U.S.C. § 119 (e) to U.S. Provisional Patent Application No. 63/471,683 filed on Jun. 7, 2023. This provisional application is hereby incorporated by reference in its entirety.

### TECHNICAL FIELD

This disclosure relates generally to image processing systems. More specifically, this disclosure relates to multi-modal facial feature extraction using branched machine learning models.

### BACKGROUND

Many electronic devices, such as smartphones, tablet computers, televisions, and other devices, include cameras that can be used to capture still and video images. Often times, these or other types of devices can perform various image processing tasks on captured images, which may be performed for any number of purposes. For example, image processing tasks may be performed in order to improve the quality of final output images generated based on the captured images or to provide desired effects within the final output images generated based on the captured images.

### SUMMARY

This disclosure relates to multi-modal facial feature extraction using branched machine learning models.

In a first embodiment, a method for using a machine learning model having a base model and multiple branch models includes obtaining an image containing a face and processing the image using the base model to generate intermediate data based on the image. The method also includes processing the intermediate data using a first branch model of the multiple branch models to perform a first image processing task, where the first image processing task is associated with analyzing the image containing the face. The method further includes processing the intermediate data using a second branch model of the multiple branch models to perform a second image processing task different from the first image processing task, where the second image processing task is associated with analyzing the image containing the face. The base model and the first branch model are trained using a first dataset, and the base model and the second branch model are trained using a second dataset different from the first dataset. In another embodiment, a non-transitory machine readable medium includes instructions that when executed cause at least one processor of an electronic device to perform the method of the first embodiment.

In a second embodiment, an electronic device includes an imaging sensor configured to capture an image containing a face. The electronic device also includes at least one processing device configured to process the image using a base model of a machine learning model to generate intermediate data based on the image. The at least one processing device is also configured to process the intermediate data using a first branch model of multiple branch models of the machine learning model to perform a first image processing task, where the first image processing task is associated with analyzing the image containing the face. The at least one processing device is further configured to process the intermediate data using a second branch model of the multiple branch models to perform a second image processing task different from the first image processing task, where the second image processing task is associated with analyzing the image containing the face. The base model and the first branch model are trained using a first dataset, and the base model and the second branch model are trained using a second dataset different from the first dataset.

In a third embodiment, a method for training a machine learning model having a base model and multiple branch models includes obtaining a first dataset for training a first branch model of the multiple branch models to perform a first image processing task, where the first image processing task is associated with analyzing images containing faces. The method also includes obtaining a second dataset for training a second branch model of the multiple branch models to perform a second image processing task different from the first image processing task, where the second image processing task is associated with analyzing the images containing the faces and where the second dataset is different from the first dataset. The method further includes training the base model and the first branch model using the first dataset and the base model and the second branch model using the second dataset. In another embodiment, an electronic device includes at least one processing device configured to perform the method of the third embodiment. In still another embodiment, a non-transitory machine readable medium includes instructions that when executed cause at least one processor of an electronic device to perform the method of the third embodiment.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B.” or “one or more of A and/or B” may include all possible combinations of A and B. For example, “A or B.” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular bead units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example network configuration including an electronic device in accordance with this disclosure;

FIGS. 2 and 3 illustrate example branched machine learning models supporting multi-modal facial feature extraction in accordance with this disclosure;

FIG. 4 illustrates an example method for training a branched machine learning model to support multi-modal facial feature extraction in accordance with this disclosure; and

FIG. 5 illustrates an example method for using a branched machine learning model to support multi-modal facial feature extraction in accordance with this disclosure.

### DETAILED DESCRIPTION

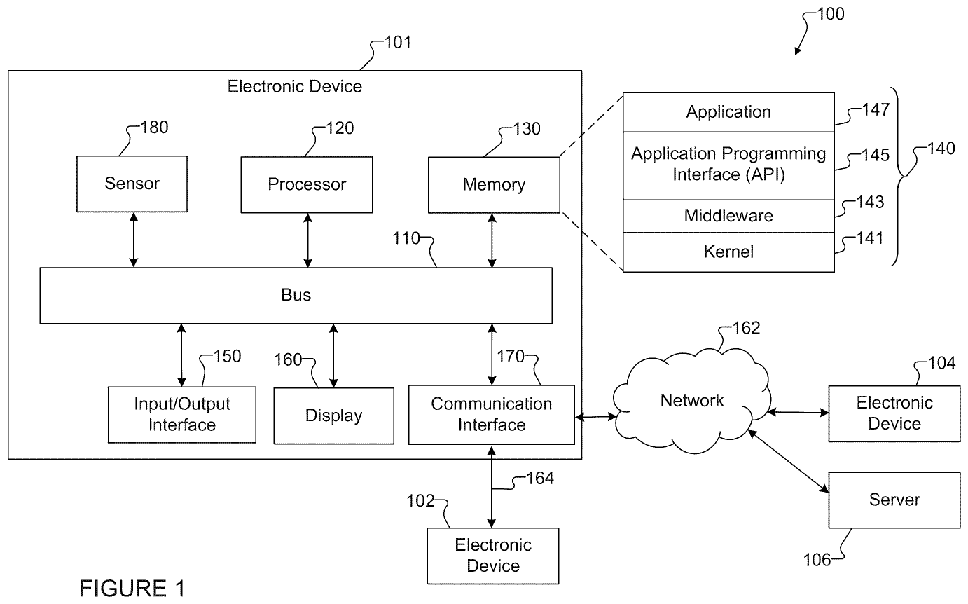

FIGS. 1 through 5, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, many electronic devices, such as smartphones, tablet computers, televisions, and other devices, include cameras that can be used to capture still and video images. Often times, these or other types of devices can perform various image processing tasks on captured images, which may be performed for any number of purposes. For example, image processing tasks may be performed in order to improve the quality of final output images generated based on the captured images or to provide desired effects within the final output images generated based on the captured images.

Some image processing tasks involve the extraction of facial features of people's faces within captured images. Humans' brains are typically capable of processing images of people's faces with minute details, and various facial features can be used to extract high-level information about people's faces in captured images. For example, machine learning models can be trained to extract high-level information about people's faces in captured images in order to perform various image processing tasks, such as tasks related to various image enhancements. Machine learning models are typically trained using training datasets, where the machine learning models adjust weights or other internal parameters in order to accurately perform their desired functions. Unfortunately, when it comes to the extraction of facial features from images, training datasets related to people's faces are often limited in quantity or scope. For instance, some training datasets include important annotations but lack diversity, while other training datasets have diversity but include relatively small numbers of images.

Not only that, there are routinely inconsistencies in annotations of facial features in training datasets based on the specific applications in which the annotations are used. For example, different image processing applications may use different information regarding people's faces in captured images. As particular examples, some image processing applications may use high-level information like facial expressions or interactions of action units, while other image processing applications may use low-level information like head positions. Most training datasets are only annotated for a single type of application. This creates a limitation in the diversity of the training datasets that can be used since data with different annotations cannot be leveraged for different applications. For instance, two high-level features that can be extracted from images are the segmentation of different parts of a person's face (such as eyes, ears, nose, mouth, skin, etc.) and the identification of facial landmarks or important features of a person's face. Training datasets for specific tasks like face segmentation are limited, while diverse datasets are available with landmark annotations but cannot be used for face segmentation training.

This disclosure provides various techniques for multi-modal facial feature extraction using branched machine learning models. As described in more detail below, a branched machine learning model can include a base model and multiple branch models. Different datasets for training different branch models to perform different image processing tasks can be obtained, and the image processing tasks can be associated with analyzing images containing faces. The base model can be trained using the different datasets, while each branch model can be trained using one or some (but not all) of the different datasets. For example, the base model and one of the branch models can be trained using one of the datasets, and the base model and another of the branch models can be trained using another of the datasets. In some cases, for each branch model, the base model and that branch model can be trained using a dataset associated with that branch model. Also, in some cases, the training of the base model and branch models can overlap, such as when training data is randomly selected from the different datasets and used to randomly train the different branch models and the base model. Further, in some cases, the base model can be trained to generate high-dimensional latent representations of faces in images, where the high-dimensional latent representations contain different discriminative information used by different ones of the branch models. In addition, in some cases, at least some of the branch models may be arranged in parallel, and optionally two or more of the branch models may be arranged to operate sequentially. Once trained, the branched machine learning model may be used to process images. For instance, an image containing a face can be obtained, and the image can be processed using the base model to generate intermediate data based on the image. The intermediate data can be processed using different branch models to perform different image processing tasks.

Because different training datasets can be used to train the base model and different branch models, the described techniques support a multitask approach for learning multiple types of semantic information from images of people's faces. Facial features are often represented in different ways, such as when face segmentation data is represented using pixel-wise annotations that provide information about what parts of a face different pixels belong to and when facial landmark data is represented using two-dimensional (2D) or three-dimensional (3D) information about pre-specified parts of a face. The techniques described in this patent document can be used to leverage various training datasets, such as those from multiple sources, having different semantic annotations. The base model can be trained to learn high-dimensional latent representations of faces, and the base model can be trained using training data from multiple datasets (where different datasets have different annotation techniques). The branch models can be trained using different datasets, such as when each branch model is trained using at least one dataset having a specific annotation technique (and where different branch models can be trained using datasets having different annotation techniques). The base model can therefore leverage data from multiple datasets (possibly collected in diverse settings) to provide robust feature representations of faces, while the individual branch models may only learn from one or some of the corresponding datasets in order to perform specific image processing tasks associated with the branch models. As a result, the described techniques can provide significant improvements in the results obtained while performing various image processing tasks.

Note that while some of the embodiments discussed below are described in the context of use in portable consumer electronic devices (such as smartphones or tablet computers), this is merely one example. It will be understood that the principles of this disclosure may be implemented in any number of other suitable contexts and may use any suitable portable or fixed devices, including televisions or other devices, that can capture and process images of people's faces.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may perform various functions related to multi-modal facial feature extraction using one or more branched machine learning models. For instance, the processor 120 may support the training of one or more branched machine learning models as described below. The processor 120 may also or alternatively support the use of one or more branched machine learning models as described below.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications for performing various functions related to multi-modal facial feature extraction using one or more branched machine learning models. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform various functions related to multi-modal facial feature extraction using one or more branched machine learning models. For instance, the server 106 may support the training of one or more branched machine learning models as described below. The server 106 may also or alternatively support the use of one or more branched machine learning models as described below.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

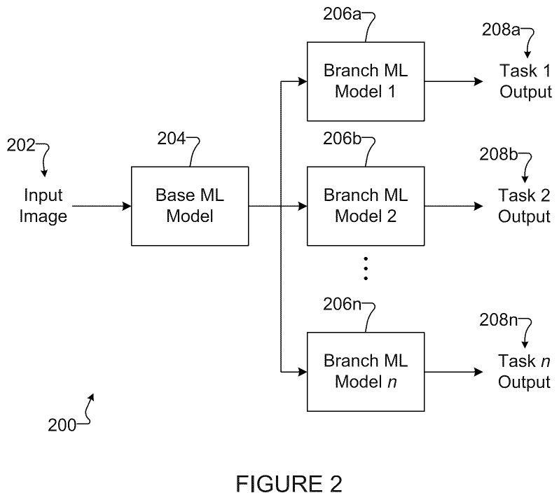

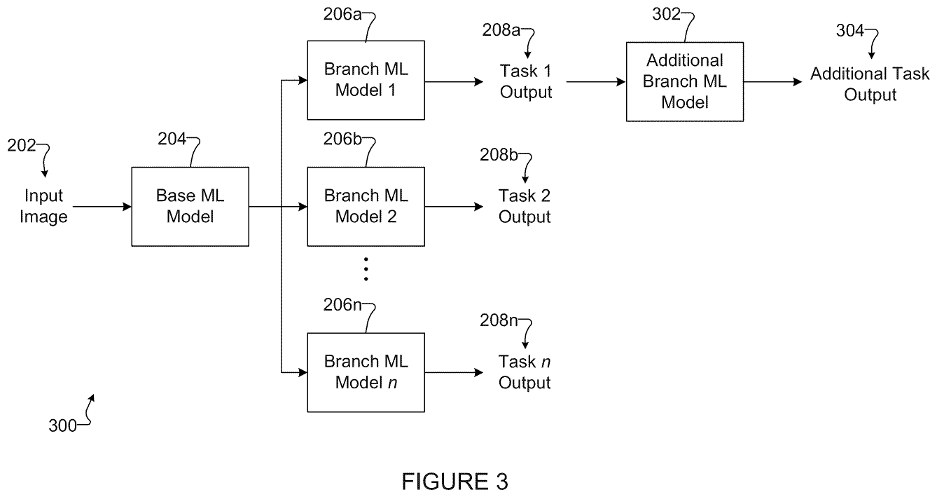

FIGS. 2 and 3 illustrate example branched machine learning models 200 and 300 supporting multi-modal facial feature extraction in accordance with this disclosure. For ease of explanation, the branched machine learning models 200 and 300 of FIGS. 2 and 3 may be described as being trained using the server 106 in the network configuration 100 of FIG. 1 and deployed for use by the electronic device 101 in the network configuration 100 of FIG. 1. However, each of the branched machine learning models 200 and 300 may be trained and used by any other suitable device(s) and in any other suitable system(s). In some cases, for instance, the branched machine learning models 200 and 300 may be trained by the server 106 and used by the server 106 to process images received from the electronic device 101.

As shown in FIG. 2, the branched machine learning model 200 generally receives and processes input images 202. Each input image 202 may be obtained from any suitable source, such as when the input image 202 is produced using one or more cameras or other imaging sensors 180 of the electronic device 101 during an image capture operation. Each input image 202 can have any suitable format, such as a Bayer or other raw image format, a red-green-blue (RGB) image format, or a luma-chroma (YUV) image format. Each input image 202 can also have any suitable resolution, such as up to fifty megapixels or more.

The branched machine learning model 200 in this example includes a base machine learning (ML) model 204 and two or more branch ML models 206a-206n. The base model 204 receives and processes each input image 202 and generates intermediate data based on the input image 202. For example, the base model 204 can be trained to generate high-dimensional latent representations of faces in the input images 202. These high-dimensional latent representations can represent accurate estimations of the facial features of the faces in the input images 202 in multiple dimensions. Each branch model 206a-206n receives and processes the intermediate data from the base model 204 and generates image processing outputs 208a-208n. For instance, each branch model 206a-206n can be trained to generate accurate outputs 208a-208n for the specific type(s) of image processing task(s) that the branch model 206a-206n is trained to perform.

Each branch model 206a-206n may be trained to perform any suitable image processing task(s) associated with analyzing images containing faces. The specific image processing tasks performed by the branched machine learning model 200 can vary depending on the application for the branched machine learning model 200. In some cases, two or more branch models 206a-206n may be trained to perform two or more of the following image processing tasks: facial segmentation, facial landmark detection, gaze estimation, head pose estimation, emotion estimation, heat map generation, physical attribute estimation, and edge detection. Facial segmentation generally refers to the process of segmenting an image to identify different parts of a person's face in the image, such as by identifying the eyes, ears, nose, mouth, skin, etc. of the person's face. The result of facial segmentation may take the form of a segmentation map, where each pixel of the segmentation map corresponds to a pixel of an input image 202 and identifies the part of the person's face that the corresponding pixel is associated with (if any). Facial landmark detection generally refers to the process of identifying facial landmarks or important features of a person's face in an image. The result of facial landmark detection may take the form of 2D or 3D information about pre-specified parts of the person's face, such as the 2D or 3D locations of the corners of the person's eyes or mouth.

Gaze estimation generally refers to the process of estimating the direction in which a person is looking in an image, which can often be based on the apparent direction in which the person's eyes are looking. The result of gaze estimation may take the form of an identified direction in which the person is looking or a location at which the person is looking. Head pose estimation generally refers to the process of estimating the direction in which a person's head is directed in an image. The result of head pose estimation may take the form of an identified direction in which the person's head is pointed or a location at which the person's head is directed. Emotion estimation generally refers to the process of estimating the emotional state of a person based on the person's facial expression in an image. The result of emotion estimation may take the form of an identified emotion.

Heat map generation generally refers to the process of identifying more important parts of a person's face in an image without attempting to identify the specific boundaries of those parts of the person's face in the image. The result of heat map generation may take the form of one or more heat maps, such as where each heat map identifies at least one portion of an image associated with at least one important part of a person's face (like a heat map roughly identifying locations of the person's eyes, a heat map roughly identifying a location of the person's nose, a heat map roughly identifying a location of the person's mouth, etc.). Physical attribute estimation generally refers to the process of estimating one or more physical characteristics of a person or the person's face in an image. The result of physical attribute estimation may take the form of one or more estimated physical characteristics, such as a person's race, age, hair color, eye color, or sex. Edge detection generally refers to the process of identifying edges of objects in an image, which may include edges of different portions of a person's face in the image. The result of edge detection may take the form of an edge map, which can identify locations within the image where object edges have been detected.

As noted above, two or more branch models 206a-206n may be used in the branched machine learning model 200 and trained to perform two or more of these image processing tasks or other or additional image processing tasks. As a particular example, some embodiments of the branched machine learning model 200 may have one branch model 206a that is trained to perform facial segmentation and another branch model 206b that is trained to perform facial landmark detection. As another particular example, some embodiments of the branched machine learning model 200 may have one branch model 206a that is trained to perform facial segmentation and another branch model 206b that is trained to perform heat map generation. In these or other embodiments, one or more branch models 206a-206n may be trained to perform one or more of gaze estimation, head pose estimation, emotion estimation, heat map generation, or physical attribute estimation. In general, this disclosure is not limited to any specific combination of image processing tasks, and any combination of image processing tasks described above or other or additional image processing tasks may be used in the branched machine learning model 200.

In the example shown in FIG. 2, the branch models 206a-206n are logically parallel with one another, which in some embodiments allows the branch models 206a-206n to operate concurrently when processing data. However, there is no requirement that all of the branch models 206a-206n be logically parallel with one another from the view of the base model 204. In other cases, one or more branch models may be dependent on one or more other branch models, such as when one branch model receives the output data generated by another branch model (rather than receiving the data generated by the base model 204). One example of this is shown in FIG. 3, where the branched machine learning model 300 includes the base model 204 and the branch models 206a-206n described above. An additional branch ML model 302 is shown here as processing the outputs 208a from the branch model 206a, where the additional branch model 302 generates additional outputs 304. The additional branch model 302 here is dependent on the branch model 206a since the additional branch model 302 receives data to be processed from the branch model 206a.

The additional branch model 302 here may be trained to perform any suitable image processing task(s). In some embodiments, for example, the branch model 206a may perform facial segmentation, and the additional branch model 302 may perform edge detection based on the facial segmentation results. Thus, for instance, the additional branch model 302 may be used to identify edges of different segmented facial features, such as when the additional branch model 302 identifies locations where the class labels in the facial segmentation results change. The class labels here are used to define which object class, such as which part of a person's face, is associated with each pixel in an image (if any).

Note that while FIG. 3 shows the branched machine learning model 300 as including two branch models 206a and 302 operating sequentially, any number of branch models may operate sequentially within a single branch of the branched machine learning model 300. Also, note that while FIG. 3 shows one branch of the branched machine learning model 300 as including multiple branch models operating sequentially, any number of branches of the branched machine learning model 300 (possibly including all branches) may include multiple branch models operating sequentially. In addition, while the additional branch model 302 is shown here as being dependent on one other branch model 206a, each additional branch model may be dependent on one other branch model or on multiple other branch models.

The base model 204 and each branch model 206a-206n, 302 may represent any suitable machine learning model that supports any desired machine learning model architecture. In some embodiments, for example, the base model 204 may represent a neural network, such as a convolution neural network. Also, in some embodiments, each branch model 206a-206n, 302 may represent a neural network, such as a convolution neural network. However, any other suitable type(s) of machine learning models may be used in the branched machine learning models 200 and 300.

Note that the results 208a-208n, 304 produced by the branched machine learning models 200 and 300 may be used to support any desired image processing applications. For example, the branched machine learning model 200 or 300 may be used to perform facial super-resolution, which refers to an application in which image data associated with a person's face undergoes super-resolution in order to increase the resolution of the image data associated with the person's face. Ideally, this helps to show the person's face in greater detail within a super-resolution image. As another example, the branched machine learning model 200 or 300 may be used to perform one or more actions based on an estimated emotional state of a person in a captured image or based on the direction in which it appears the person's head is pointed or the person's eyes are gazing. As still another example, the branched machine learning model 200 or 300 may be used to support interactive or social robots, chatbots, or other automated systems that are designed to interact with humans and (ideally) should be able to emulate human expressions naturalistically. In this last example, having an understanding of human faces can be helpful in designing systems that fulfill these roles. In general, however, this disclosure is not limited to any specific use(s) of the results 208a-208n, 304 produced by the branched machine learning models 200 and 300.

In some embodiments, training of the branched machine learning models 200 and 300 may occur as follows. For the components of the branched machine learning model 200 shown in FIG. 2 or the corresponding components of the branched machine learning model 300 shown in FIG. 3, the branched machine learning model is trained to perform N image processing tasks (where N≥2). Assume each image processing task is associated with a different one of the N branch models 206a-206n, and assume each branch model 206a-206n is being trained to perform one or more operations using facial features extracted from one or more input images 202. Also assume that each of the N branch models 206a-206n is to be trained using a respective training dataset D₁-D_{N}. While it is assumed here that each branch model 206a-206n is trained using one training dataset, this is for ease of explanation only, and each branch model 206a-206n may be trained using any suitable number of training datasets. Each training dataset includes multiple training image-annotation pairs, where (i) the training image can be processed by the base model 204 and the associated branch model 206a-206n during training and (ii) the annotation can represent the desired output(s) from the associated branch model 206a-206n that should be generated based on the training image. Here, the base model 204 can be trained using all of the training datasets D₁-D_{N}, while each individual branch model 206a-206n can be trained using its associated training dataset D₁-D_{N}.

During the training process, a training image-annotation pair can be selected (possibly randomly) from an i^{th} training dataset Dᵢ, where i=1, . . . , N. The training image is denoted as imᵢ, and the annotation is denoted as annᵢ. The i^{th} training dataset Dᵢ is used to train the i^{th} branch model and the base model 204. For example, differences or errors between the expected output from the i^{th} branch model (the annotation annᵢ) and the actual output from the i^{th} branch model (which can be denoted as y_{pred,i}) can be used to determine a loss for the i^{th} branch model. Any suitable measure of loss may be used here, such as cross-entropy loss, mean absolute loss, weighted mean absolute loss, or mean squared loss. In some cases, different loss functions can be used for different branch models. The loss for the i^{th} branch model may be defined as Loss=Lᵢ(annᵢ, y_{pred,i}), where Lᵢ( ) represents the loss function. By selecting various training image-annotation pairs from the training datasets D₁-D_{N}, loss values can be determined for the branch models 206a-206n. The loss for each branch model may be used, such as via backpropagation or other techniques, to modify weights or other parameters of both the i^{th} branch model and the base model 204 based on the loss. This process can be repeated over any desired number of iterations. Training may typically occur until either (i) each branch model 206a-206n generates results 208a-208n that are considered suitably accurate or (ii) some other criterion or criteria are satisfied (such as a maximum training time or a maximum number of training iterations being reached).

As a particular example of a training process, take the example above of the branched machine learning model 200 that includes two branch models 206a (for facial segmentation) and 206b (for facial landmark detection). A training dataset for the branch model 206a can include training images and annotations that define the correct or desired segmentations of those training images. Another training dataset for the branch model 206b can include training images and annotations that define the correct or desired facial landmarks to be identified in those training images. A training image-annotation pair can be selected (possibly randomly) from one of the datasets. If the training image-annotation pair comes from the facial segmentation training dataset, the training image is provided to the base model 204, and intermediate data generated by the base model 204 is provided to the branch model 206a for generation of facial segmentation results. The generated facial segmentation results are compared to the annotation facial segmentation results in order to determine a loss, and backpropagation or other techniques can be used to modify at least one of the branch model 206a and the base model 204 based on the loss. If the training image-annotation pair comes from the facial landmark detection training dataset, the training image is provided to the base model 204, and intermediate data generated by the base model 204 is provided to the branch model 206b for generation of facial landmark results. The generated facial landmark results are compared to the annotation facial landmark results in order to determine a loss, and backpropagation or other techniques can be used to modify at least one of the branch model 206b and the base model 204 based on the loss. This can be repeated for some, many, or all of the training image-annotation pairs from the datasets.

Each additional branch model 302 may or may not be trained in the same or similar manner. In some cases, for instance, each additional branch model 302 may be trained using training data for that additional branch model 302, and only the additional branch model 302 (not the base model 204 or a preceding branch model in a sequence of branch models) may be modified during training of the additional branch model 302. In other cases, each additional branch model 302 may be trained using training data for that additional branch model 302, and the additional branch model 302, the base model 204, and the preceding branch model in a sequence of branch models may be modified during training of the additional branch model 302.

Although FIGS. 2 and 3 illustrate examples of branched machine learning models 200 and 300 supporting multi-modal facial feature extraction, various changes may be made to FIGS. 2 and 3. For example, each branched machine learning model 200 and 300 may include any suitable number of branch models, at least some of which are arranged in parallel to process intermediate data generated by the base model 204. The branched machine learning model 300 may also include any suitable number of additional branch models 302.

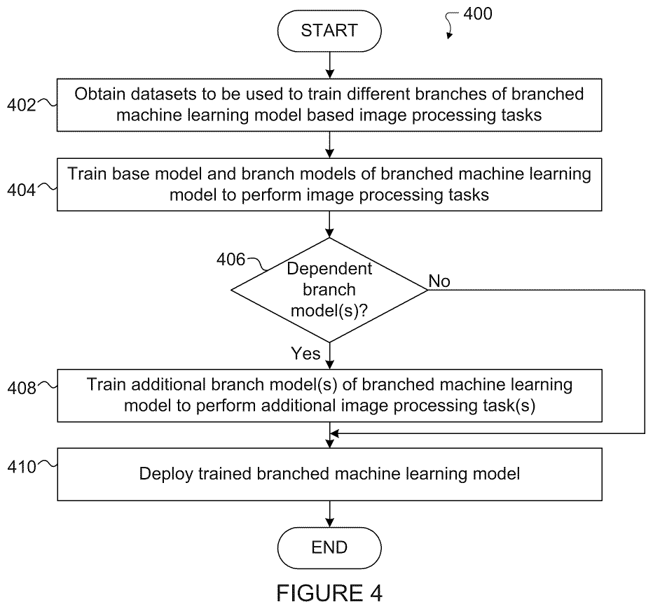

FIG. 4 illustrates an example method 400 for training a branched machine learning model to support multi-modal facial feature extraction in accordance with this disclosure. For ease of explanation, the method 400 shown in FIG. 4 is described as being performed by the server 106 in the network configuration 100 shown in FIG. 1, where the server 106 can be used to train a branched machine learning model 200 or 300 shown in FIG. 2 or 3. However, the method 400 shown in FIG. 4 could be performed by any other suitable device(s) and in any other suitable system(s), such as when the method 400 is performed using the electronic device 101. Also, the method 400 may be used to train any other suitable branched machine learning model designed in accordance with this disclosure.

As shown in FIG. 4, datasets to be used to train different branches of a branched machine learning model are obtained at step 402. The branched machine learning model includes a base model 204 and two or more branch models 206a-206n, optionally along with one or more dependent or additional branch models 302. This may include, for example, the processor 120 of the server 106 obtaining different training datasets to be used to train different branch models 206a-206n of a branched machine learning model 200 or 300. This may also include the processor 120 of the server 106 optionally obtaining one or more additional training datasets to be used to train one or more additional branch models 302 of the branched machine learning model 200 or 300. The training datasets can be obtained from any suitable source(s), and the training datasets are based on specific image processing tasks to be performed using the branch models 206a-206n and any additional branch model(s) 302 of the branched machine learning model 200 or 300.

The base model and the branch models of the branched machine learning model are trained to perform various image processing tasks at step 404. This may include, for example, the processor 120 of the server 106 selecting training image-annotation pairs from various training datasets (possibly randomly) and providing the training images from the pairs to the base model 204. This may also include the processor 120 of the server 106 using the base model 204 to generate intermediate data, such as high-dimensional latent representations of faces in the training images. This may further include the processor 120 of the server 106, for each training image-annotation pair, processing the intermediate data generated using the training image in the pair with the branch model 206a-206n associated with the training dataset from which the training image-annotation pair is selected. In addition, this may include the processor 120 of the server 106 identifying losses based on the outputs 208a-208n generated by the branch models 206a-206n and the associated annotations and using backpropagation or other techniques to modify the base model 204 and the associated branch models 206a-206n based on the losses. This can be repeated using any number of training image-annotation pairs from the various training datasets. The branch models 206a-206n here can be trained to perform various image processing tasks associated with analyzing images containing faces, and the base model 204 here can be trained to extract high-dimensional latent representations of the faces in the images (where the high-dimensional latent representations are useful for the branch models 206a-206n).

If there are one or more dependent branch models to be trained at step 406, one or more additional branch models are trained to perform one or more additional image processing tasks at step 408. This may include, for example, the processor 120 of the server 106 training one or more additional branch models 302, each of which can be dependent on the outputs from at least one previous branch model. Again, the server 106 may use training image-annotation pairs to train each additional branch model 302. In this example, the training of each additional branch model 302 is shown as occurring separate from the training of the base model 204 and the branch models 206a-206n. However, as noted above, the additional branch model(s) 302 may be trained in combination with the training of the base model 204 and the branch models 206a-206n, in which case steps 404 and 408 may overlap. This may allow, for instance, the additional branch model(s) 302 to be jointly trained with the base model 204 and any branch model(s) 206a-206n on which the additional branch model(s) 302 may depend if desired.

Once training of the branched machine learning model is completed, the trained branched machine learning model is deployed for use at step 410. This may include, for example, the processor 120 of the server 106 providing the trained branched machine learning model 200 or 300 to one or more electronic devices, such as the electronic device 101, for use in processing input images 202 and performing the image processing tasks for which the branched machine learning model 200 or 300 has been trained to perform. This may also or alternatively include the processor 120 of the server 106 using the trained branched machine learning model 200 or 300 to perform the image processing tasks.

Although FIG. 4 illustrates one example of a method 400 for training a branched machine learning model to support multi-modal facial feature extraction, various changes may be made to FIG. 4. For example, while shown as a series of steps, various steps in FIG. 4 may overlap, occur in parallel, occur in a different order, or occur any number of times (including zero times).

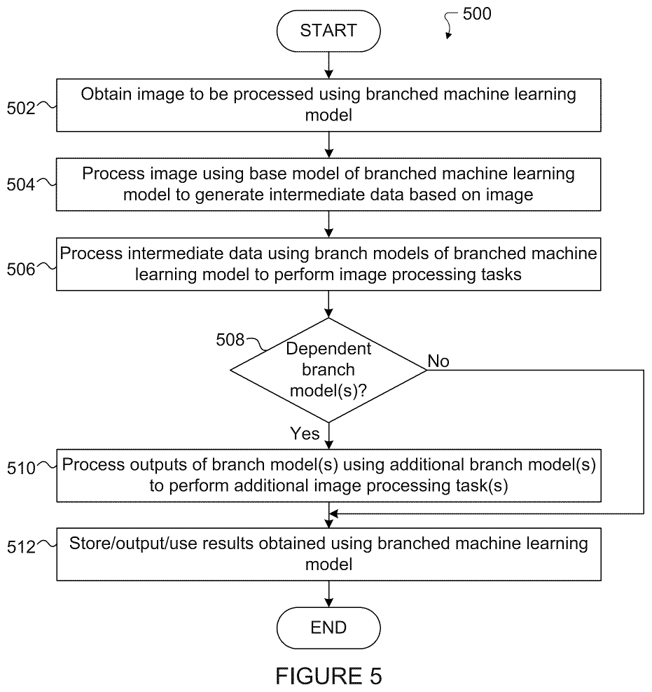

FIGURE S illustrates an example method 500 for using a branched machine learning model to support multi-modal facial feature extraction in accordance with this disclosure. For ease of explanation, the method 500 shown in FIG. 5 is described as being performed by the electronic device 101 in the network configuration 100 shown in FIG. 1, where the electronic device 101 can use a trained branched machine learning model 200 or 300 shown in FIG. 2 or 3 (which may be trained using the method 400 shown in FIG. 4). However, the method 500 shown in FIG. 5 could be performed by any other suitable device(s) and in any other suitable system(s), such as when the method 500 is performed using the server 106. Also, the method 500 may be used with any other suitable branched machine learning model designed in accordance with this disclosure.

As shown in FIG. 5, an image to be processed using a branched machine learning model is obtained at step 502. This may include, for example, the processor 120 of the electronic device 101 obtaining an input image 202, such as by using one or more imaging sensors 180 of the electronic device 101.

The image is processed using the base model of the branched machine learning model to generate intermediate data based on the image at step 504. This may include, for example, the processor 120 of the electronic device 101 processing the input image 202 using the base model 204 of the branched machine learning model 200 or 300 to generate high-dimensional latent representations of any faces in the input image 202. The intermediate data is processed using multiple branch models of the branched machine learning model in order to perform multiple image processing tasks at step 506. This may include, for example, the processor 120 of the electronic device 101 processing the high-dimensional latent representations using the branch models 206a-206n of the branched machine learning model 200 or 300 to generate outputs 208a-208n. These outputs 208a-208n represent the respective results of the image processing tasks performed by the branch models 206a-206n.

If there are one or more dependent branch models in the branched machine learning model at step 508, one or more additional branch models are used to perform one or more additional image processing tasks at step 510. This may include, for example, the processor 120 of the electronic device 101 providing the outputs 208a from the branch model 206a to an additional branch model 302, which can process the outputs 208a and generate additional outputs 304. These outputs 304 represent the results of the image processing task(s) performed by the additional branch model 302. Note that this can be done for any number of additional branch models 302 (if any). Also note that at least one additional branch model 302 may itself receive the outputs 304 from at least one other additional branch model 302. In other words, the additional branch models 302 may be arranged in any suitable manner within the branched machine learning model 300.

The results obtained using the branched machine learning model are stored, output, or used in some manner at step 512. The specific use of the results can easily vary depending on the application of the branched machine learning model 200 or 300. For example, there are various ways in which results from facial segmentation, facial landmark detection, gaze estimation, head pose estimation, emotion estimation, heat map generation, physical attribute estimation, and/or edge detection may be used. While various examples are provided above, the results obtained using the branched machine learning model 200 or 300 may be used in any suitable manner and for any suitable purpose(s).

Although FIG. 5 illustrates one example of a method 500 for using a branched machine learning model to support multi-modal facial feature extraction, various changes may be made to FIG. 5. For example, while shown as a series of steps, various steps in FIG. 5 may overlap, occur in parallel, occur in a different order, or occur any number of times (including zero times).

It should be noted that the functions shown in or described with respect to FIGS. 2 through 5 can be implemented in an electronic device 101, server 106, or other device(s) in any suitable manner. For example, in some embodiments, at least some of the functions shown in or described with respect to FIGS. 2 through 5 can be implemented or supported using one or more software applications or other software instructions that are executed by the processor 120 of the electronic device 101, server 106, or other device(s). In other embodiments, at least some of the functions shown in or described with respect to FIGS. 2 through 5 can be implemented or supported using dedicated hardware components. In general, the functions shown in or described with respect to FIGS. 2 through 5 can be performed using any suitable hardware or any suitable combination of hardware and software/firmware instructions. Also, the functions shown in or described with respect to FIGS. 2 through 5 can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method for using a machine learning model comprising a base model and multiple branch models, the method comprising:
obtaining an image containing a face;
processing the image using the base model to generate intermediate data based on the image;
processing the intermediate data using a first branch model of the multiple branch models to perform a first image processing task, the first image processing task associated with analyzing the image containing the face; and
processing the intermediate data using a second branch model of the multiple branch models to perform a second image processing task different from the first image processing task, the second image processing task associated with analyzing the image containing the face;
wherein the base model and the first branch model are trained using a first dataset and the base model and the second branch model are trained using a second dataset different from the first dataset.

2. The method of claim 1, wherein:
the first image processing task comprises facial segmentation; and
the second image processing task comprises facial landmark detection.

3. The method of claim 1, wherein at least one of the multiple branch models is configured to perform at least one of: gaze estimation, head pose estimation, emotion estimation, heat map generation, and physical attribute estimation.

4. The method of claim 1, further comprising:
processing the intermediate data using a third branch model of the multiple branch models to perform a third image processing task different from the first and second image processing tasks.

5. The method of claim 1, further comprising:
providing outputs of the first branch model to an additional branch model of the machine learning model, the additional branch model configured to perform an additional image processing task.

6. The method of claim 5, wherein:
the first image processing task comprises facial segmentation;
the second image processing task comprises facial landmark detection; and
the additional image processing task comprises edge detection.

7. The method of claim 1, wherein the intermediate data generated by the base model comprises a high-dimensional latent representation of the face in the image, the high-dimensional latent representation containing different discriminative information used by different ones of the multiple branch models.

8. An electronic device comprising:
an imaging sensor configured to capture an image containing a face; and
at least one processing device configured to:
process the image using a base model of a machine learning model to generate intermediate data based on the image;
process the intermediate data using a first branch model of multiple branch models of the machine learning model to perform a first image processing task, the first image processing task associated with analyzing the image containing the face; and
process the intermediate data using a second branch model of the multiple branch models to perform a second image processing task different from the first image processing task, the second image processing task associated with analyzing the image containing the face;
wherein the base model and the first branch model are trained using a first dataset and the base model and the second branch model are trained using a second dataset different from the first dataset.

9. The electronic device of claim 8, wherein:
the first image processing task comprises facial segmentation; and
the second image processing task comprises facial landmark detection.

10. The electronic device of claim 8, wherein at least one of the multiple branch models is configured to perform at least one of: gaze estimation, head pose estimation, emotion estimation, heat map generation, and physical attribute estimation.

11. The electronic device of claim 8, wherein the at least one processing device is further configured to process the intermediate data using a third branch model of the multiple branch models to perform a third image processing task different from the first and second image processing tasks.

12. The electronic device of claim 8, wherein the at least one processing device is further configured to provide outputs of the first branch model to an additional branch model of the machine learning model, the additional branch model configured to perform an additional image processing task.

13. The electronic device of claim 12, wherein:
the first image processing task comprises facial segmentation;
the second image processing task comprises facial landmark detection; and
the additional image processing task comprises edge detection.

14. The electronic device of claim 8, wherein the intermediate data generated by the base model comprises a high-dimensional latent representation of the face in the image, the high-dimensional latent representation containing different discriminative information used by different ones of the multiple branch models.

15. A method for training a machine learning model comprising a base model and multiple branch models, the method comprising:
obtaining a first dataset for training a first branch model of the multiple branch models to perform a first image processing task, the first image processing task associated with analyzing images containing faces;
obtaining a second dataset for training a second branch model of the multiple branch models to perform a second image processing task different from the first image processing task, the second image processing task associated with analyzing the images containing the faces, the second dataset different from the first dataset; and
training the base model and the first branch model using the first dataset and the base model and the second branch model using the second dataset.

16. The method of claim 15, wherein:
the first image processing task comprises facial segmentation; and
the second image processing task comprises facial landmark detection.

17. The method of claim 15, wherein at least one of the multiple branch models is configured to perform at least one of: gaze estimation, head pose estimation, emotion estimation, heat map generation, and physical attribute estimation.

18. The method of claim 15, further comprising:
obtaining a third dataset for training a third branch model of the multiple branch models to perform a third image processing task different from the first and second image processing tasks, the third dataset different from the first and second datasets; and
training the base model and the third branch model using the third dataset.

19. The method of claim 15, further comprising:
training an additional branch model of the machine learning model to perform an additional image processing task, the additional branch model dependent on the first branch model.

20. The method of claim 19, wherein:
the first image processing task comprises facial segmentation;
the second image processing task comprises facial landmark detection; and
the additional image processing task comprises edge detection.
